(19) United States
(12) Patent Application Publication
(10) Pub. No.: US 2024/0340520 A1
(43) Pub. Date: Oct. 10, 2024

(54) SYSTEM FOR FOLLOWING ACTORS ON AT LEAST ONE PERFORMANCE STAGE

(71) Applicant: XYZED, Paris (FR)

(72) Inventors: Maurice REBIFFE, Paris (FR); Christian Jean Jacques HUBERT, Charenton le Pont (FR)

(21) Appl. No.: 18/690,891

(22) PCT Filed: Aug. 30, 2022
(86) PCT No.: PCT/FR2022/051627

§ 371 Date: Mar. 11, 2024

(30) Foreign Application Priority Data
Sep. 9, 2021 (FR) FR2109435

(51) Int. Cl. H04N 23/61; H04N 9/31; H04N 13/221

(52) U.S. Cl. CPC H04N 23/61; H04N 9/3185; H04N 13/221

(57) ABSTRACT

A system for tracking performers on a show stage, includes: a plurality of projectors, at least one motorized yoke with direct axial drive for the support and the omnidirectional movement of an assembly including: an image acquisition assembly formed of color and neuromorphic cameras having a common objective lens, a dichroic mirror, an image processing module to receive, from the neuromorphic camera, event-related images of the performers in order to determine their coordinates and to receive, from the color camera, visible images of these performers allowing them to be identified, and a display screen to display a visible image of each of the performers obtained by the color camera and to allow the assignment by an operator at a control terminal or a media server of the determined projectors to identified performers on the stage, to ensure automatic tracking by the projectors of the respective movements of these identified performers.

### TECHNICAL FIELD

The present invention relates to the field of tracking objects or living beings and it more particularly concerns a system for tracking performers on one or more show stages based on the visual and audio image of these performers.

### PRIOR ART

The tracking of objects or living beings, humans or animals, moving on a show stage is a difficult problem to solve. The systems based on the sole image recognition to ensure such tracking of these different performers are hardly efficient because they are particularly sensitive to the lighting conditions of the stage. This is in particular the case in the circus when the performers to be tracked are very numerous and perform simultaneously on several rings, on the ground as well as in the air, and where the traditional vision and recognition methods do not manage to validly understand all their moves.

### DISCLOSURE OF THE INVENTION

The present invention proposes to overcome these lighting conditions and to overcome the aforementioned drawbacks with a simple device allowing a tracking of performers performing on several stages capable of forming a large tracking volume without excessive constraints.

These aims are achieved with a system for tracking performers on a show stage, including: a plurality of light or video projectors to track the movement of the performers on the stage,
at least one motorized yoke having at least two axes of rotation with direct axial drive for the support and the omnidirectional movement of an assembly comprising:
an image acquisition assembly formed of a color camera and of a neuromorphic camera, and having a common objective lens, to receive images of the performers performing on the stage, and
a dichroic mirror separating and directing the image collected through the common objective lens, on the one hand towards the color camera and on the other hand towards the neuromorphic camera,
an image processing module to receive, from the neuromorphic camera, event-related images of the performers performing on the stage in order to determine their coordinates and to receive from, the color camera, visible images of these performers allowing them to be identified if necessary, and
a display screen to display a visible image of each of the performers performing on the stage obtained by the color camera and to allow the assignment by an operator at a control terminal or a media server of the determined light or video projectors to identified performers on the stage, in order to ensure automatic tracking by the light or video projectors of the respective movements of these identified performers.

Thus, the receipt of event-related images by the neuromorphic camera associated with the receipt of visible images by the color camera, these two cameras being mounted on a motorized omnidirectional yoke, allows the location, identification and tracking of the performers by the light or video projectors with great ease.

Preferably, the motorized yoke further includes an infrared diode module to illuminate the volume of the stage.

Advantageously, the tracking system further includes infrared identifiers intended to be worn by each of the performers.

Preferably, it further includes an array projector to calibrate the color and neuromorphic cameras so as to define a tracking volume.

Advantageously, the motorized yoke further includes a power supply and control module as well as a wired, radio or light data communication module.

The invention also relates to a method for tracking performers on a show stage including:
orienting towards the stage at least one motorized yoke supporting an image acquisition assembly formed of a color camera and of a neuromorphic camera, and having a common objective lens,
obtaining an event-related image of each of the performers present on the stage by the neuromorphic camera and obtaining a visible image of each of the performers performing on the stage by the color camera,
identifying the performers and determining the coordinates of each of them based on their event-related image and on their visible image,
displaying, on a display screen, a visible image of each of the performers performing on the stage to allow the assignment by an operator at a control terminal or a media server of determined light or video projectors to identified performers on the stage, in order to ensure automatic tracking by the light or video projectors of the respective movements of these identified performers.

Preferably, the method further includes illuminating the volume of the stage by means of an infrared diode module integrated into the motorized yoke to create contrasts of light on each of the performers and facilitate their identification by the neuromorphic camera or the timestamp of the coordinates and their transmission to scenery machinery or a sound console.

Advantageously, a first prior step of calibrating the color and neuromorphic cameras by means of an array projector defining a tracking volume is provided.

Preferably, the identification of the performers can be ensured by facial recognition from the images coming from the color camera or by an infrared identifier worn by each of the performers and analyzed by the neuromorphic camera.

### BRIEF DESCRIPTION OF THE DRAWINGS

The characteristics and advantages of the present invention will emerge better from the following description, given for informational and non-limitating purposes, in relation to the appended drawings in which:

FIG. 1 is a schematic view of a show stage including a system for tracking performers according to the invention,

FIG. 2 is a view of a motorized yoke of the performer tracking system of FIG. 1,

FIGS. 3A-3B illustrates an example of two co-axial cameras and an example of an infrared diode module supported by the motorized yoke of FIG. 2, and

FIG. 4 shows the different steps of the performer tracking method according to the invention.

### DESCRIPTION OF THE EMBODIMENTS

To allow the tracking of performers moving on one or more show stages, the invention proposes to mount a color camera and a neuromorphic camera in a motorized support with two or preferably three axes of rotation (Tilt, Pan, Roll), perpendicular in pairs, of the yoke type and to associate them with several external show projectors to detect and track, in real time with these projectors, the movement of the different performers appearing on the stage. The identification of the performers is preferably ensured by an identity recognition coming from the images of the cameras, but the use of tag-type infrared identifiers carried by each of the performers is also envisaged.

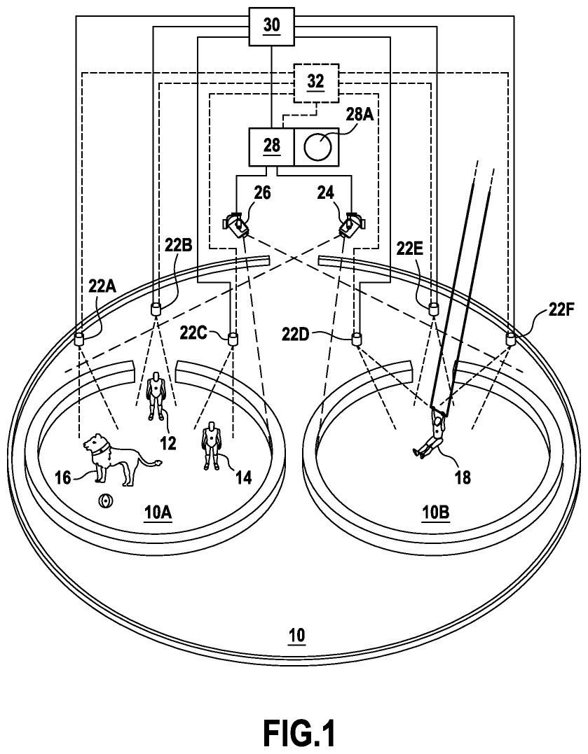

FIG. 1 illustrates an example of a circus tent 10 including two show rings 10A, 10B capable of receiving performers, for example two clowns 12, 14 and an animal with a balloon 16 on the first ring and a trapeze artist 18 on the second ring.

In accordance with the invention, a system 20 for tracking these different performers is disposed under the tent 10. It is formed of several light or video projectors 22A-22F, of at least one motorized yoke 24, 26 in wired, radio or light link with an outer image processing module 28 integrating a display screen 28A and a control terminal 30, typically a light console responsible for controlling the movement of the light projectors and able to be equipped with its own display screen. When the projectors are video projectors, the control of their movement is ensured not by the light console but by a media server 32 (traditionally associated with at least one display screen) which can be a video multimedia server, or a multimedia player equipped with a video controller in bidirectional link with the video projectors and which can then possibly integrate the image processing module 28.

It will be recalled that with a light projector, the shadow of the person or of the object is projected and the impact of the light beam appears at the back of this person or this object whereas with a video projector only the impacted surface (for example all or part of the silhouette of a performer) is lighted, no shadow being projected. By “radio link”, it is meant a wireless link of the WiFi type or the like and by “light link”, it is meant a wireless link of the LiFi type. The choice of either of these communication technologies essentially depends on the (mechanical as well as electrical) configuration of the tent.

The image processing module 28 and its screen 28A can be any type of computer or microprocessor calculator provided with appropriate image processing software including facial recognition (in case of identification detection) and known to those skilled in the art.

The light or video projectors 22A-22F implemented in the invention are components known per se which therefore need not be described in detail. It will only be noted that a light projector includes a source of white light with lamps or LEDs which passes through a gobo wheel to deliver a plurality of light beams with different effects through an output objective lens equipped with a zoom and a focus, and that a video projector includes at least a laser light source and a projection engine and it can however also include an optical fiber to ensure the transport of white light from the laser light source to the projection engine. The laser light source is for example an RGB laser light source as known from Application WO2016/113490 or Application WO2016/156759, both filed in the name of the Applicant and making it possible to concentrate different light beams coming from laser diodes at a determined focal point at the output of this laser light source. The projection engine is traditionally organized around a light modulator, a prism and an optical block including in particular projection lenses ensuring zoom and focus and forming the objective lens of the projector. The light modulator is traditionally a DMD (digital micromirror device) array, but other configurations can also be used such as an LCD, Lcos or D-ILA array and tri-LCD or tri-DMD arrays. In practice, any type of video projector can be implemented in the invention.

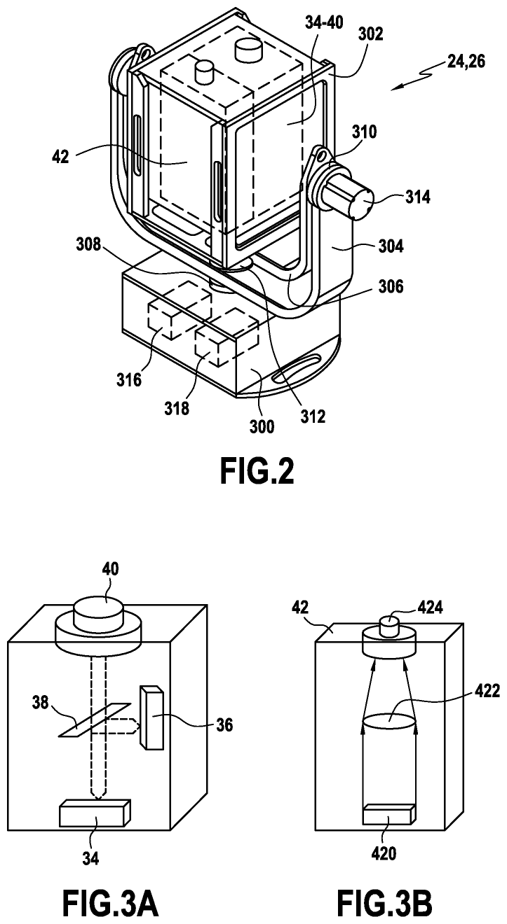

As shown in FIG. 2, the motorized yoke 24, 26, advantageously portable yoke (its weight is less than 30 kg) intended to receive, in a support frame 302, an image acquisition assembly and possibly an infrared diode module, includes two “L”-shaped arms 304, 306 each having a first and a second end, the first end 304A of the first arm 304 being connected to a base 300 at the level of a first vertical axis of rotation (horizontal “Pan” axis 308) and the second end 304B of the first arm 304 being connected to the first end 306A of the second arm 306 at the level of a second horizontal axis of rotation (vertical “Tilt” axis 310) perpendicular to the first vertical axis of rotation 308, the second end 306B of the second arm 306 being connected to the support frame 302 at the level of a third vertical axis of rotation 312 perpendicular to the second horizontal axis of rotation (“Roll” axis 310) and coaxial (in its rest position) to the first vertical axis of rotation 308. Each axis of rotation 308, 310, 312 is motorized by a motor-reduction gear assembly (for example 314) in direct connection with this axis of rotation (direct axial drive), that is to say without a pulley or a belt generating vibrations (jolts during accelerations or decelerations) and significant hysteresis (or backlash). The motors are typically stepper type motors or for example brushless direct current motors advantageously provided with an electromagnetic brake and the reduction gears are very high-accuracy moto-reduction assemblies of the elliptical reduction gear type from the company Harmonic Drive® for example whose accuracy is advantageously comprised between 15 and 30 Arc second (i.e. between 0.004 and) 0.0083°. The range of displacement of the axes of rotation is typically 380° on the “Pan” axis, 270° on the “Tilt” axis and 180° on the “roll” axis which allows a switching from a landscape mode to a portrait mode and vice versa.

Of course, if this L-shaped configuration of the motorized yoke is preferred, a more traditional and symmetrical U-shaped configuration can also be envisaged. In this case, only one of the two ends of the U-shaped arm is preferably motorized, the other can then be freewheel mounted on a simple non-motorized axis of rotation.

FIG. 3A-3B more specifically shows the image acquisition assembly formed of the two cameras called co-axial cameras supported by the motorized yoke and including a color camera 34 and a neuromorphic camera 36 both receiving images through a dichroic mirror 38 disposed at 45° behind a common objective lens 40 ensuring zoom and focus as well as band-pass filtering whose bandwidth is variable to allow optimization of the contrast. The dichroic mirror receives the image of the object which on the one hand, by crossing it, will be directed towards this color camera 34 and on the other hand, by returning perpendicularly to this optical axis, will be directed towards the neuromorphic camera 36. To let the visible image pass towards the color camera, the dichroic mirror includes a transmission wavelength band comprised between 400 and 700 nm, and to reflect the infrared image towards the neuromorphic camera it includes a rejection wavelength band comprised between 700 and 900 nm. The control of these zoom and focus of the common objective lens can be managed by a power supply and control module 316 necessary for the voltage supply and the control of the displacement of the motorized yoke on its different axes according to data transfer protocols known as RS485, DMX512, Art-Net or PSN (Position Stage Net). The figure also represents in the base of the motorized yoke a wired, radio or light data communication module 318 ensuring a wired link or a radio or light wireless link with the outer image processing module 28 and the control terminal 30 or the media server 32.

The motorized yoke, whether with a single (L) or double (U) arm, achieves a perfect balance of masses with a center of gravity that allows supporting high weights (from 20 to more than 100 Kg) without significant lever arms and therefore ensures perfect mechanical servo-control without vibrations and with exceptional placement accuracy, movement quality and repeatability. This balanced structure allows the motorized yoke to be used in any position, suspended or kept offset laterally, or even laid on its base on the ground. Reference will advantageously be made to the Application FR20 01934 filed in the name of the Applicant.

The color camera 34 implemented in the invention is known per se and it is therefore not necessary to describe it in detail. It should just be noted that it includes at least one sensor (a color camera with three RGB sensors is also possible) which can be with CMOS or EMCCD technology (see for example the color cameras of the IK-M series from the company Toshiba). The analysis of the visible images coming from this camera allows, for example by means of identity (or facial) recognition software known per se, an identification of each of the performers.

The neuromorphic camera 36 is also known per se and is for example described in Application WO2020/120782 in the name of the company Prophesee®. It has the particularity of allowing the identification and tracking of objects based on an array of event-based sensors which delivers events asynchronously and beyond a predetermined threshold according to the variations in the parameters (intensity, luminance, reflectance) of the light received on this array of sensors. By processing on each image only a small amount of information, it benefits from negligible processing latency compared to a conventional camera and can process 20,000 images per second when a conventional camera processes only 200 of them. It therefore allows detection in all circumstances thanks to its time response of the order of 50 microseconds and its exceptional light detection dynamics of 120 dB (compared to the 40 dB of a conventional camera). When the identification of the performers is not carried out by the color camera, the neuromorphic camera can handle it by analyzing the event-related image or more simply by collecting the information coming from the IR tags carried by each of them (and illustrated in FIG. 1 by the black dot on each person, animal or object). These IR tags are typically IR emitters (800 to 974 nm wavelength) sequenced at different frequencies comprised between 2 and 20 KHz to differentiate each of the tags.

In order to create in all circumstances a detectable event for the neuromorphic camera, in particular a stationary or quasi-stationary object a priori undetectable (because it does not generate events below the predetermined threshold), the neuromorphic camera is advantageously provided with specific means of action on the common objective lens 40 like those known from the Application WO2021/089216.

Alternatively, and as shown in FIG. 3A-3B, infrared illumination of the stage can be created by an infrared diode module 42 including a set 420 of laser diodes or light-emitting diodes (LED) whose parallel beams of infrared light are returned on a focusing lens 422 before passing through a zoom output objective lens 424. This module integrated into the motorized yoke 24, 26 lights the entire volume of the stage, so as to create light contrasts on each of the performers impacted by this illumination in order to better stand out from their environment and facilitate the processing of images and in particular a possible identification of the performers by the neuromorphic camera. This illumination makes it possible to detect the moving objects not equipped with IR tags, such as scenery elements or external participants.

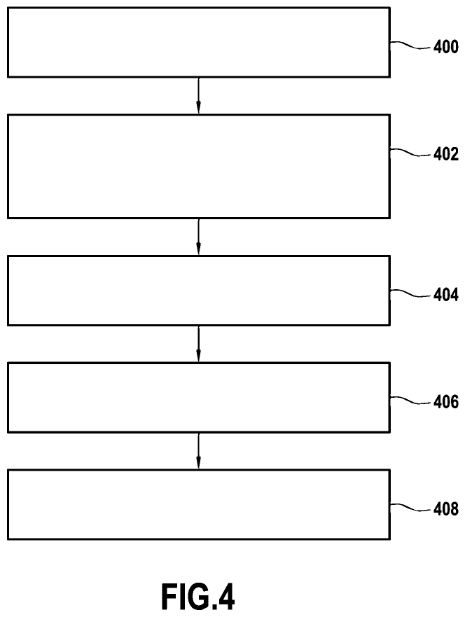

The operational operation of the invention illustrated by the different steps of the method of FIG. 4 will now be described with reference to the example of FIG. 1 which shows two rings of a circus tent under which a tracking system according to the invention is mounted including two motorized yokes 24, 26 and a set of 6 projectors.

Prior to this operational operation, a calibration step of the image acquisition assembly is of course carried out. This is traditionally carried out by means of an array projector known per se projecting a choice of grids, lines or dots or any other graphics (via a wheel of several gobos) in order to determine the volume (programmable for example in portrait or landscape mode and in a ratio 16/9, 16/10, 4/3 or the like depending on the configuration of the tent) in which the performers will perform (typically this array projector can be one of the light or video projectors). By “volume”, it is meant the dimensions of the stage in X (width of the stage), Y (height of the stage) and Z (depth of the stage) which can be calculated automatically by placing an IR tag at each corner of the perimeter, that is to say both at the back of the stage (backstage) and on the edge of the stage (forestage) and at different heights. The neuromorphic camera captures these reference points and the image processing module automatically calculates the volume.

In a first step 400, the motorized yoke is oriented towards the ring where the performers to be tracked will appear. This orientation of the motorized yoke (corresponding to the “Pan”, “Tilt” and “Roll” angles) which is controlled directly from the control terminal 30, obviously involves that of the common objective lens 40 of the cameras and possibly that of the infrared diode module (if present), which the yoke supports towards the ring chosen by the operator. This command responds to the choice of an orientation (this orientation can advantageously be memorized) carried out by the operator by means of a simple joystick or trackball associated with the display screen of the control terminal (or possibly with the advantageously touch screen 28A). When the two rings are going to be animated and the tracking system includes two motorized yokes as illustrated, it is appropriate to orient the first motorized yoke 24 towards the first ring 10A and the second motorized yoke 26 towards the second ring 10B but, when a large number of performers appear on the same ring, it may on the contrary be appropriate to direct the two motorized yokes towards this first ring alone. On the other hand, if the tracking system only includes a single motorized yoke, this can be alternately oriented towards the first then the second ring according to the needs of the show (this is for example the case where a first artist is performing on the first stage while a second artist is getting ready on the second stage).

It will be noted that when several motorized yokes operate jointly, for example to form a larger tracking volume, it is advantageous to designate the one as master and the others as slaves to facilitate the passage of performers from one tracking area to another without interruption of their tracking between these two areas.

In a second step 402, the neuromorphic camera 36, through an image analysis based on asynchronous events, will obtain an event-related image of each of the performers present in its field of vision determined by the orientation of the yoke, and the color camera 34 (whose orientation is also that of the yoke) will obtain a visible image of the stage with each of the performers for a display on the display screen 28A. In a following step 404, via the image processing module 28 (or the media server 32 if it incorporates this module) and by using image recognition software known in itself, accurate coordinates of each of these performers are determined and each of the performers identified by using facial recognition software or otherwise by means of the infrared tag that these performers can wear.

In a new step 406, these coordinates are time stamped with the visible images obtained by the color camera 34 and communicated to the control terminal 30 or to the media server 32 when the latter is present. This achievement of a visible image of the object further allows the operator to confirm the presence of the performers and to locate them accurately on the show ring(s) after having been detected and identified (possibly via their tags) by the neuromorphic camera 36. The association of the visible image and of the event-related image also allows the image processing module to produce a perfect silhouette effect (cropping of the image) of the performers which allows the projectors in the final step 408 to automatically follow them on a ring or during a passage from one ring to another.

This tracking of the final step is controlled by the operator stationed in front of the control terminal 30 or in front of the media server 32 which will dedicate (individually assign, preferentially at the display screen associated with the terminal or with the media server, but a recourse to the touch screen 28A is also possible) one or more projectors to track the previously identified performers as they move on the ring. When the projectors are simple light projectors, the positioning information allowing this tracking is sent to these light projectors from the control terminal 30 and when these projectors are video projectors, this positioning information and the silhouette effect of the performers as they move are sent to these video projectors from the media server 32. It will be noted that this information can also be communicated to machinery manipulating scenery elements or to a sound console ensuring the sound spatialization.

1.-15. (canceled)

16. A system for tracking performers on a show stage, including:
a plurality of light or video projectors to track the movement of the performers on the stage,
at least one motorized yoke having at least two axes of rotation with direct axial drive for the support and the omnidirectional movement of an assembly comprising:
an image acquisition assembly formed of a color camera and of a neuromorphic camera, and having a common objective lens, to receive images of the performers performing on the stage,
a dichroic mirror separating and directing the image collected through the common objective lens, on the one hand towards the color camera and on the other hand towards the neuromorphic camera, and
an image processing module to receive, from the neuromorphic camera, event-related images of the performers performing on the stage in order to determine their coordinates and to receive, from the color camera, visible images of these performers allowing them to be identified if necessary, and
a display screen to display a visible image of each of the performers performing on the stage obtained by the color camera and to allow the assignment by an operator at a control terminal or a media server of the determined light or video projectors to identified performers on the stage, in order to ensure automatic tracking by the light or video projectors of the respective movements of these identified performers.

17. The tracking system according to claim 16, wherein the motorized yoke further includes an infrared diode module to illuminate the volume of the stage.

18. The tracking system according to claim 16, further comprising infrared identifiers intended to be worn by each of the performers.

19. The tracking system according to claim 18, wherein the infrared identifiers are IR emitters sequenced at different frequencies comprised between 2 and 20 KHz.

20. The tracking system according to claim 16, including several motorized yokes and wherein to facilitate the tracking between several areas, a first motorized yoke is a master yoke, and the other motorized yokes are slave yokes.

21. The tracking system according to claim 16, further including an array projector to calibrate the color and neuromorphic cameras so as to define a tracking volume.

22. The tracking system according to claim 16, wherein the motorized yoke further includes a power supply and control module as well as a wired, radio or light data communication module.

23. A method for tracking performers on a show stage including:
orienting towards the stage at least one motorized yoke supporting an image acquisition assembly formed of a color camera and of a neuromorphic camera, and having a common objective lens,
obtaining an event-related image of each of the performers present on the stage by the neuromorphic camera and obtaining a visible image of each of the performers performing on the stage by the color camera,
identifying the performers and determining the coordinates of each of them based on their event-related image and their visible image,
displaying, on a display screen, a visible image of each of the performers performing on the stage to allow the assignment by an operator at a control terminal or a media server of the determined light or video projectors to identified performers on the stage, in order to ensure automatic tracking by the light or video projectors of the respective movements of these identified performers.

24. The tracking method according to claim 23, further including illuminating the volume of the stage by means of an infrared diode module integrated into the motorized yoke to create contrasts of light on each of the performers and facilitate their identification by the neuromorphic camera.

25. The tracking method according to claim 23, further including the timestamp of the coordinates and their transmission to stagey machinery or a sound console.

26. The tracking method according to claim 23, further including a first prior step of calibrating the color and neuromorphic cameras by means of an array projector defining a tracking volume.

27. The tracking method according to claim 23, wherein the identification of the performers is ensured by facial recognition from the images coming from the color camera.

28. The tracking method according to claim 23, wherein the identification of the performers is ensured by an infrared identifier worn by each of the performers and analyzed by the neuromorphic camera.

29. The tracking method according to claim 28, wherein each of the infrared identifiers is an IR emitter sequenced at a different frequency comprised between 2 and 20 KHz.

30. The tracking method according to claim 23, wherein the assignment of the light or video projectors to the different performers is carried out by the operator by means of a simple joystick or trackball of the control terminal or the media server.
